(19) United States
(12) Patent Application Publication
(10) Pub. No.: US 2016/0283272 A1
(43) Pub. Date: Sep. 29, 2016

(54) SHARED RESOURCE ACCESS CONTROL METHOD AND APPARATUS

(71) Applicant: Intel Corporation, Santa Clara, CA (US)

(72) Inventor: James A. Coleman, Mesa, AZ (US)

(21) Appl. No.: 14/668,044

(22) Filed: Mar. 25, 2015

(51) Int. Cl. G06F 9/50; G06F 9/48

(52) U.S. Cl. CPC G06F 9/5011; G06F 9/4881

(57) ABSTRACT

Apparatuses, methods and storage media associated with monitoring and controlling core access of a shared resource are disclosed herein. In embodiments, an apparatus may include a processor having a plurality of cores; a resource coupled with the processor to be shared among the plurality of cores; and a plurality of performance counters correspondingly associated with the plurality of cores to store access budgets of the shared resource of the plurality of cores. The apparatus may further include a performance monitor to manage access of the shared resource by the plurality of cores in accordance with their respective access budgets stored in the performance counters. Other embodiments may be described and/or claimed.

### TECHNICAL FIELD

The present disclosure relates to the field of computing. More particularly, the present disclosure relates to apparatus and method for monitoring and controlling access of a shared resource by various cores of a multi-core processor.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

When a real-time application is run concurrently with other applications on a processor with multiple cores and a shared last level cache (LLC), the shared LLC and memory of the system can become congested when the other applications running on other cores issue a larger number of LLC or memory references in a short period of time. This shared resource congestion is manifest as higher LLC latency and memory latency, which can result in failure of the real-time application.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a computing arrangement with shared resource access control technology of the present disclosure, according to various embodiments.

FIG. 2 illustrates an example process for monitoring and controlling core access of a shared resource in accordance with their respective access budgets, according to various embodiments.

FIG. 3 illustrates an example process for configuring a control register and a number of performance counters for monitoring and controlling core access of a shared resource in accordance with their respective access budgets, according to various embodiments.

FIG. 4 illustrates an example process for handling a core reaching its access budget, according to various embodiments.

FIG. 5 illustrates an example computer system suitable for practicing aspects of the present disclosure, according to various embodiments.

FIG. 6 illustrate a storage medium having instructions to enable an apparatus to practice aspects of the present disclosure, according to various embodiments.

### DETAILED DESCRIPTION

Apparatuses, methods and storage media associated with monitoring and controlling core access of a shared resource are disclosed herein. In embodiments, an apparatus may include a processor having a plurality of cores; a resource (e.g., LLC or memory) coupled with the processor to be shared among the plurality of cores; and a plurality of performance counters correspondingly associated with the plurality of cores to store access budgets of the shared resource of the plurality of cores. The apparatus may further include a performance monitor to manage access of the shared resource by the plurality of cores in accordance with their respective access budgets stored in the performance counters. These and other aspects of the shared resource access control technology of the present disclosure will be described in further detail.

In the following detailed description, the shared resource access control technology will be described with references to the accompanying drawings which form a part hereof, wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

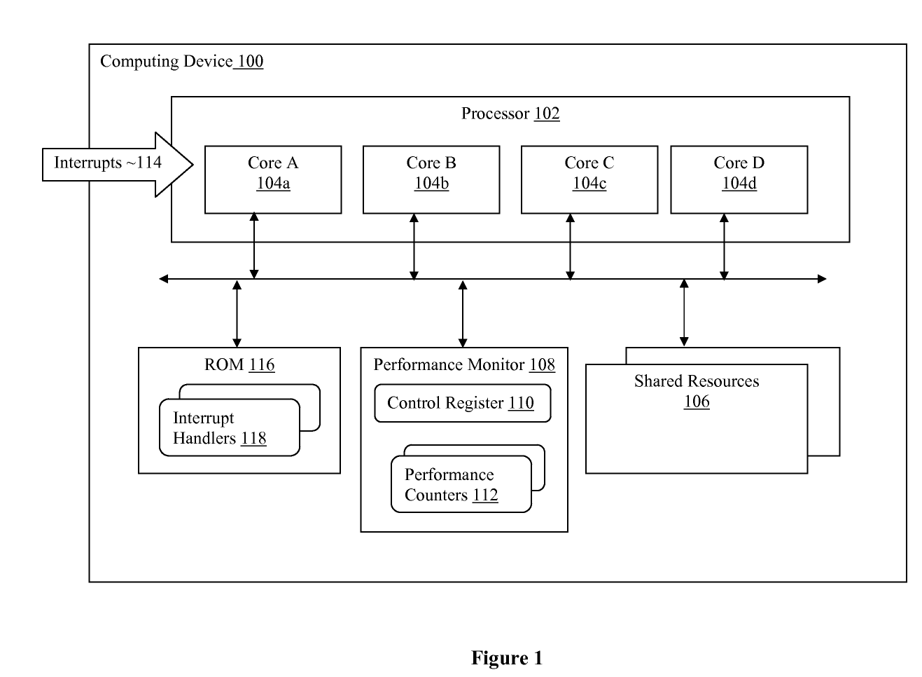

Referring now FIG. 1, wherein a computing arrangement with shared resource access control technology of the present disclosure, according to various embodiments, is shown. As illustrated, computing device 100 may include a processor 102 having a number of cores 104a-104d and one or more resources 106, such as LLC, memory, and so forth, coupled with, and shared among cores 104a-104d. Additionally, computing device 100 may further include performance monitor 108 configured to monitor and control access of one or more resources 106 by cores 104a-104d, in accordance with the respective access budgets of cores 104a-104d. In embodiments, the access budgets may be set per budget quantum, e.g., for x milliseconds, and/or by access event type, e.g., with distinctions between LLC accesses vs memory accesses.

In embodiments, computing device 100 may further include control register 110 and performance counters 112. Control register 110 may be configured to store control data that indicate which, if any, of cores 104a-104d are to have budget based access control of a share resource 106 enabled. Additionally, control register 110 may also be configured to store control data that indicate the next budget check time of the various access budgets. Performance counters 112 may be configured to store the respective access budgets. In embodiments, each performance counter 112 may be configured to store an access budget of a budget time quantum for all or one access event type. Further, each performance counter 112 may be configured to implicitly store an access budget of a budget time quantum, by storing a value that is equal to the overflow value minus the access budget of the budget time quantum, such that an overflow of the performance counter 112 would occur when the access budget is reached within the budget time quantum. Still further, computing device 100 may further include circuitry (not shown) for triggering/generating an interrupt 114, e.g. a non-maskable interrupt, for processor 102, and each performance counter 112 may be configured to cause the circuitry to trigger/generate such as interrupt on overflow.

For the embodiments depicted by FIG. 1, control register 110 and performance counters 112 are shown as part of performance monitor 108. For these embodiments, performance monitor 108 may be a hardware component with the monitoring and control logic implemented as firmware of the hardware component. In alternate embodiments, control register 110 may be implemented as part of processor 102, whereas performance monitors 112 may be respectively implemented as part of cores 104a-104d. For these alternate embodiments, the monitoring and control logic may be implemented as part of an operating system (OS) or a hypervisor (not shown) of computing device 100. In still other embodiments, multiple control registers may be employed instead.

Still referring to FIG. 1, for the embodiments of FIG. 1 with performance counters 112 configured to cause interrupt 114 to be triggered/generated when the access budget for a shared resource for a core is reached in a budget time quantum, computing device 100 may further include read-only memory (ROM) 116 coupled with processor 102, performance monitor 108 and shared resources 106, as shown. ROM 116 may include interrupt handlers 118 to service interrupts 114 when triggered/generated. In alternate embodiments, interrupt handlers 118 may reside in other volatile or non-volatile memory.

While for ease of understanding, processor 102 has been depicted with four (4) cores 104a-104d, the present disclosure is not so limited. The shared access control technology of the present disclosure may be practiced with any one of a number of multi-core processors with two (2) or more cores.

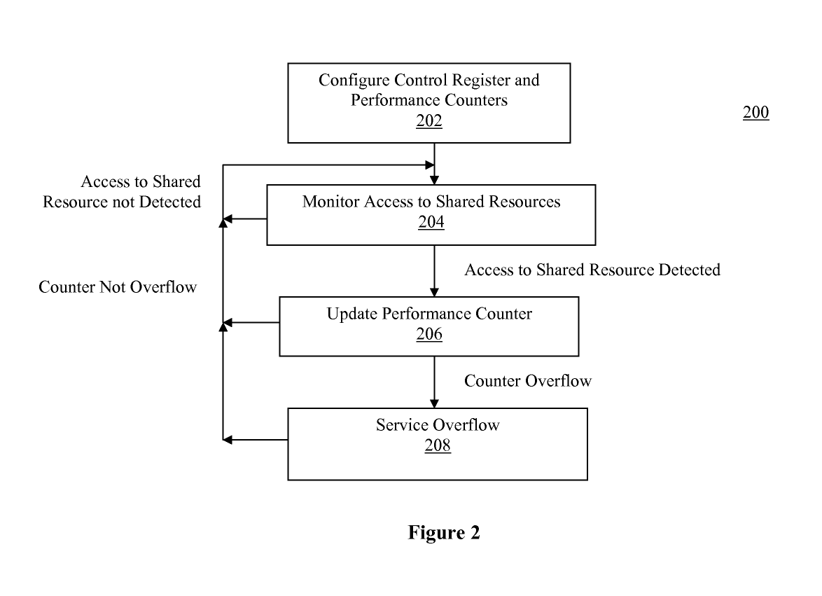

Referring now to FIG. 2, wherein an example process for monitoring and controlling core access of a shared resource in accordance with their respective access budgets, according to various embodiments, is shown. As illustrated, process 200 for monitoring and controlling core access of a shared resource in accordance with their respective access budgets may include operations performed at blocks 202-208. The operations may be performed e.g. by the earlier described performance monitor 108 of FIG. 1.

Process 200 may start at block 202. At block 202, a control register and various performance counters of a computing device may be configured. As described earlier, the control register may be configured to store control data that indicate which, if any, of the processor cores of a processor of the computing device are to have budget based access control of a share resource enabled. Further, control register may be configured to store, for each of the processor core to have budget based access control of the share resource, control data that indicate the next budget check time (based on a budget time quantum of the access budget). As also described earlier, each performance counter corresponds to processor core to have budget based access control of the share resource enabled, may be configured to store an access budget of a budget time quantum for all or one access event type for the processor core. In embodiments, each performance counter may be configured to implicitly store an access budget of a budget time quantum, by storing a value that is equal to the overflow value minus the access budget of the budget time quantum, such that an overflow of the performance counter would occur when the access budget is reached within the budget time quantum. Further, each performance counter 112 may be configured to cause the interrupt circuitry to trigger/generate an interrupt on overflow.

At block 204, access to the shared resources may be monitored. Process 200 may remain at block 204 when no access to the shared resources is detected. On detection of an access of a shared resource by a processor core, process 200 may proceed to block 206. At block 206, the corresponding performance counter may be updated to reflect the making of the access. In embodiments where the performance counter is configured to overflow when the access budget is reached, the performance counter may be incremented to reflect the access made. On update of the performance counter, resulting in no overflow, process 200 may return to block 204, and continue therefrom as earlier described.

However, on update of the performance counter, resulting in an overflow, process 200 may proceed to block 208. At block 208, the interrupt may be serviced. On servicing of the interrupt, process 200 may return to block 204, and continue therefrom as earlier described.

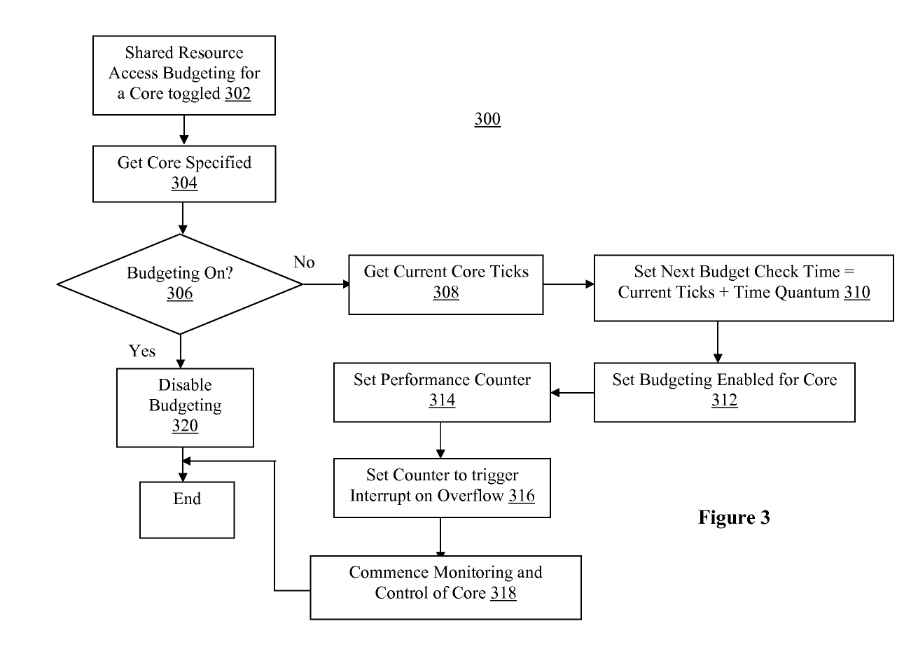

Referring now to FIG. 3, wherein an example process for configuring a control register and a number of performance counters for monitoring and controlling core access of a shared resource in accordance with their respective access budgets, according to various embodiments, is shown. As illustrated, process 300 for configuring a control register and a number of performance counters for monitoring and controlling core access of a shared resource in accordance with their respective access budgets may include operations performed at blocks 302-320. In embodiments, the operations may be performed e.g. by performance monitor 108 of FIG. 1.

Process 300 may start at block 302. At block 302, a switch associated with enabling budget based control of access to a shared resource (for an access event type) for a core may be toggled. At block 304, the core to have budget based control of access to a shared resource (for an access event type) may be determined. At block 306, a determination may be made on whether budget based control of access to a shared resource (for an access event type) is already enabled for the core. On a determination that budget based control of access to a shared resource (for an access event type) is already enabled for the core, process 300 may proceed to block 320. At block 320, budget based control of access to a shared resource (for an access event type) for the core may be disabled. Thereafter, process 300 may end.

On the other hand, if budget based control of access to a shared resource (for an access event type) is not already enabled for the core, process 300 may proceed to block 308. At block 308, the current core ticks may be obtained. Next, at block 310, the next budget check time for the core (for an access event type) may be set. In embodiments, the next budget check time for the core (for an access event type) may be set equal to the sum of current ticks, plus the budget time quantum for the core (for an access event type). At block 312, budget based control of access to a shared resource (for an access event type) may be enabled for the core.

At block 324, a corresponding performance counter may be set to store the access budget for the budget time quantum for accessing the share resource (for an access event type) for the core, as earlier described. In embodiments, the access budget and the budget time quantum may be defaulted and/or learned overtime from operational experience of the computing device. In other embodiments, an administrator may be prompted for the access budget and the budget time quantum.

At block 316, for embodiments that employ the interrupt mechanism to address access budgets having been reached, the performance counter may be configured to cause an interrupt (e.g., an NMI) to be triggered on reaching the access budget (e.g., when the performance counter overflows). Then, at block 318, the performance monitor may be notified to commence monitoring and control of access of the shared resource by the core (for an access event type), in accordance with the access budget. Thereafter, process 300 may end.

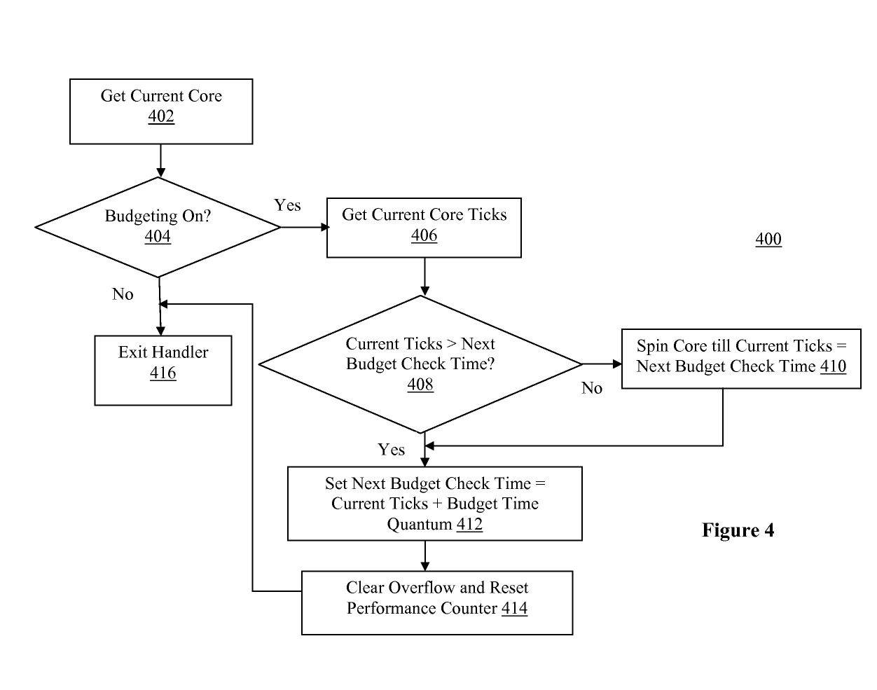

Referring now to FIG. 4, wherein an example process for handling a core reaching its access budget for accessing a shared resource (for an access event type), according to various embodiments, is shown. As illustrated, process 400 for handling a core reaching its access budget for accessing a shared resource (for an access event type) may include operations performed at blocks 402-416. In embodiments, the operations may be performed e.g. by interrupt handler 118 of FIG. 1.

Process 400 may start at block 402. At block 402, on receipt of execution control, the current core may be determined. Next, at block 404, a determination may be made on whether budget based access control to a shared resource (for an access event type) for the current core is enabled. If budget based access control to a shared resource (for an access event type) for the current core is not enabled, process 400 may proceed to block 416, where process 400 may end. For the interrupt handler embodiments, the interrupt handler may exit.

On the other hand, if budget based access control to a shared resource (for an access event type) for the current core is determined to be enabled at block 404, process 400 may proceed to block 406. At block 406, the core ticks of the current core may be obtained, e.g. by reading certain control registers of the current core. At block 408, a determination may be made on whether the current ticks are greater than the next budget check time. If a result of the determination indicates that the current ticks are greater than the next budget check time, process 400 may proceed to block 412. However, if a result of the determination indicates that the current ticks are not greater than the next budget check time, process 400 may first proceed to block 410. At block 410, the current core may be spun till the current ticks of the current core equals next budget check time.

At block 412, whether proceeded to directly from block 408 or after having spun the current core at block 410, the next budget check time may be updated to equal the sum of the current ticks of the current core and the budget time quantum (for the access event type) of the current core. Then, at block 414, the overflow may be cleared, and the performance counter may be reset with the access budget again. From block 414, process 400 may proceed to block 416, where process 400 may end. For the interrupt handler embodiments, the interrupt handler may be exited.

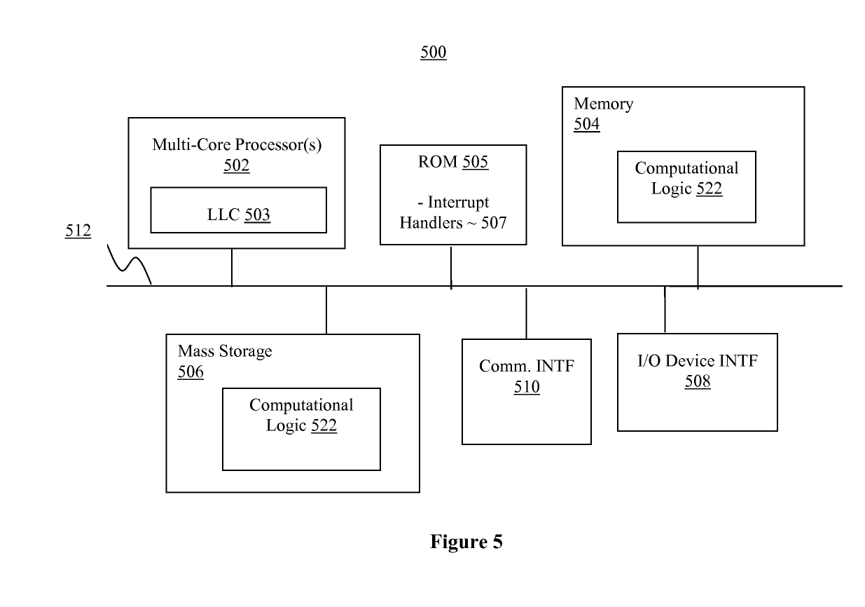

FIG. 5 illustrates an example computer system suitable for practicing various aspects of the shared access control technology of the present disclosure. As shown, computer 500 may include one or more multi-core processors 502, each having a plurality of cores and a LLC 503 shared by the cores. Further, each multi-core processor 502 may include earlier described control register 110 of FIG. 1, and each core may include the corresponding performance counters 112 of FIG. 1.

Computer 500 may further include ROM 505, system memory 504 and mass storage 506. In embodiments, ROM 502 may include a number of interrupt handlers, in particular, interrupt handler 118 of FIG. 1, and system memory 504 may be employed to store a working copy of the programming instructions implementing a hypervisor/operating system and various applications, collectively referred to as computational logic 522. In embodiments, the hypervisor/operating system may include the monitoring and control logic of performance monitor 108 of FIG. 1. Mass storage devices 506 may be employed to store a permanent copy of the programming instructions implementing computational logic 522. In embodiments, computational logic 522 may be implemented by assembler instructions supported by processor(s) 502 or high-level languages, such as, for example, C, that can be compiled into such instructions.

Further, computer 500 may include input/output device interfaces 508 (for interfacing with I/O devices such as display, keyboard, cursor control and so forth) and communication interfaces 510 for communication devices (such as network interface cards, modems and so forth). The elements may be coupled to each other via system bus 512, which may represent one or more buses. In the case of multiple buses, they may be bridged by one or more bus bridges (not shown). Additionally, computer 500 may include mass storage devices 506 (such as diskette, hard drive, compact disc read only memory (CD-ROM) and so forth).

The number, capability and/or capacity of these elements 510-512 may vary, depending on whether computer 500 is used as a client or a server device. In particular, when use as client device, the capability and/or capacity of these elements 510-512 may vary, depending on whether the client device is a stationary or mobile device, like a smartphone, computing tablet, ultrabook or laptop. Except for the shared resource access control technology of the present disclosures, the constitutions of elements 510-512 are known, and accordingly will not be further described.

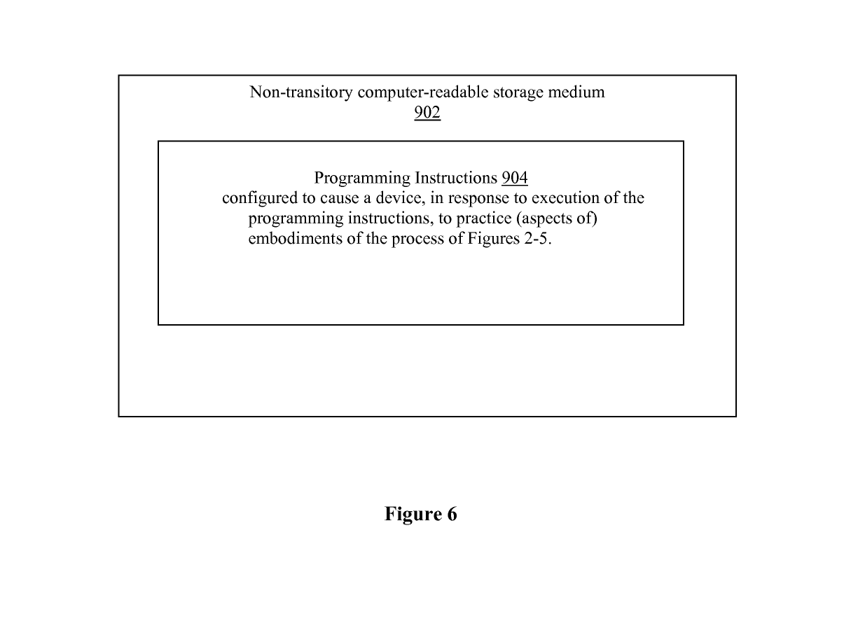

FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer 500, in response to execution of the programming instructions, to perform, e.g., various operations associated with performance monitor 108 and/or interrupt handler 118 of FIG. 1. In alternate embodiments, programming instructions 604 may be disposed on multiple computer-readable non-transitory storage media 602 instead. In alternate embodiments, programming instructions 604 may be disposed on computer-readable transitory storage media 602, such as, signals.

Referring back to FIG. 5, for one embodiment, at least one of processors 502 may be packaged together with memory having the monitoring and control logic of performance monitor 108 and/or interrupt handler 118. For one embodiment, at least one of processors 102 may be packaged together with memory having the monitoring and control logic of performance monitor 108 and/or interrupt handler 118 to form a System in Package (SiP). For one embodiment, at least one of processors 102 may be integrated on the same die with memory having the monitoring and control logic of performance monitor 108 and/or interrupt handler 118. For one embodiment, at least one of processors 102 may be packaged together with memory having the monitoring and control logic of performance monitor 108 and/or interrupt handler 118 to form a System on Chip (SoC). For at least one embodiment, the SoC may be utilized in, e.g., but not limited to, a wearable device, a smartphone or computing tablet.

Thus various example embodiments of the present disclosure have been described including, but are not limited to:

Example 1 may be a computing device, comprising: a processor having a plurality of cores; and a resource coupled with the processor to be shared among the plurality of cores. The computing device may further comprises a plurality of performance counters correspondingly associated with the plurality of cores to store access budgets of the shared resource of the plurality of cores; and a performance monitor coupled with the processor, the resource and the performance counters to manage access of the shared resource by the plurality of cores in accordance with their respective access budgets stored in the performance counters.

Example 2 may be example 1, further comprising a control register; wherein the performance monitor may be further coupled with the control register, and use the control register, in conjunction with the performance counters to manage access of the shared resource by the plurality of cores in accordance with their respective access budgets.

Example 3 may be example 2, wherein the performance monitor may further configure the control register to denote which of the plurality of cores are to have budget based control of access of the shared resource enabled.

Example 4 may be example 3, wherein the performance monitor may further configure the control register to denote a next budget check time, based on a budget time quantum, for each of the plurality of cores to have budget based control of access of the shared resource enabled.

Example 5 may be example 2, wherein the control register may be part of the performance monitor.

Example 6 may be example claim 2, wherein the control register may be part of the processor.

Example 7 may be example 1, wherein the performance monitor may configure each performance counter corresponding to a core to have budget based control of access of the shared resource enabled, with an access budget for a budget time quantum.

Example 8 may be example 7, wherein the access budget for a budget time quantum may be associated with a type of access events of the shared resource.

Example 9 may be example 7, wherein the performance monitor may configure each performance counter corresponding to a core to have budget based control of access of the shared resource enabled, with a value equal to an overflow value minus the access budget for the budget time quantum.

Example 10 may be example 9, wherein the performance monitor may configure each performance counter corresponding to a core to have budget based control of access of the shared resource enabled, to generate an interrupt on overflow.

Example 11 may be example 7, wherein the performance counters may be part of the performance monitor.

Example 12 may be example 7, wherein the performance counters may be part of the processor.

Example 13 may be example 1-12, wherein the performance monitor may monitor for accesses of the shared resource by the plurality of cores, and on detection of an access of the shared resource by a core, updates a corresponding performance counter if the accessing core has budget based control of access of the shared resource enabled.

Example 14 may be example 13, wherein the performance monitor may deny a core with budget based control of access of the shared resource enabled, from further access of the shared resource, on detection of an indication from the corresponding performance counter that denotes the core as having reached its access budget for a budget time quantum.

Example 15 may be example 14, further comprising an interrupt handler to be given execution control to deny the core with budget based control of access of the shared resource enabled, from further access of the shared resource, in response to an interrupt generated as a result of a corresponding performance counter reaches a condition that denotes the core as having reached its access budget for the budget time quantum.

Example 16 may be example 15, wherein on given execution control, the interrupt handler may: determine a current core; determine whether budget based access control of the shared resource is enabled for the current core; and on a determination that budget based access control of the shared resource is enabled for the current core, further determine whether current ticks of the current core are greater than a next budget check time of the current core.

Example 17 may be example 16, wherein on a determination that current ticks of the current core are not greater than a next budget check time of the current core, the interrupt handler may spin the current core until current ticks of the current core equal the next budget check time of the current core.

Example 18 may be example 16, wherein on a determination that current ticks of the current core are greater than a next budget check time of the current core, the interrupt handler may: set the next budget check time of the current core to a sum of the current ticks of the current core and a budget time quantum of the current core; and reset the corresponding performance counter of the current core which condition results in the interrupt that led to the interrupt handler being given execution control, with an access budget for a budget time quantum.

Example 19 may be example 1, wherein the performance monitor may be part of an operating system or hypervisor of the computing device.

Example 20 may be a method for controlling core accesses to a shared resource on a computing device, comprising: configuring, by a performance monitor of the computing device, each of a plurality of corresponding performance counters of a plurality of cores of a processor of the computing device with an access budget of the corresponding core for the shared resource for a budget time quantum; and monitoring and controlling, by the performance monitor, access of the shared resource by the cores, in accordance with the access budgets of the cores, utilizing the performance counters.

Example 21 may be example 20, wherein configuring may further comprise configuring a control register with control data associated with the access budget, and monitoring and controlling further comprises utilizing the control register.

Example 22 may be example 21, wherein configuring may comprise configuring the control register to denote which of the plurality of cores are to have budget based control of access of the shared resource enabled.

Example 23 may be example 22, wherein configuring may comprise configuring the control register to denote a next budget check time, based on a budget time quantum, for each of the plurality of cores to have budget based control of access of the shared resource enabled.

Example 24 may be example 20, wherein configuring may comprise configuring each performance counter corresponding to a core to have budget based control of access of the shared resource enabled, with an access budget for a budget time quantum.

Example 25 may be example 24, wherein the access budget for a budget time quantum is associated with a type of access events of the shared resource.

Example 26 may be example 24, wherein configuring may comprise configuring each performance counter corresponding to a core to have budget based control of access of the shared resource enabled, with a value equal to an overflow value minus the access budget for the budget time quantum.

Example 27 may be example 26, wherein configuring may comprise configuring each performance counter corresponding to a core to have budget based control of access of the shared resource enabled, to generate an interrupt on overflow.

Example 28 may be any one of examples 20-27, wherein monitoring and controlling may comprise monitoring for accesses of the shared resource by the plurality of cores, and on detecting an access of the shared resource by a core, updating a corresponding performance counter if the accessing core has budget based control of access of the shared resource enabled.

Example 29 may be example 28, wherein monitoring and controlling may comprise denying a core with budget based control of access of the shared resource enabled, from further access of the shared resource, on detecting an indication from the corresponding performance counter that denotes the core as having reached its access budget for a budget time quantum.

Example 30 may be example 29, wherein monitoring and controlling may further comprise transferring execution control to an interrupt handler to deny the core with budget based control of access of the shared resource enabled, from further access of the shared resource, in response to an interrupt generated as a result of a corresponding performance counter reaches a condition that denotes the core as having reached its access budget for the budget time quantum.

Example 31 may be example 30, wherein the method may further comprise the interrupt handler, on given execution control: determining a current core; determining whether budget based access control of the shared resource is enabled for the current core; and on determining that budget based access control of the shared resource is enabled for the current core, further determining whether current ticks of the current core are greater than a next budget check time of the current core.

Example 32 may be example 31, wherein the method may further comprise the interrupt handler, on determining that current ticks of the current core are not greater than a next budget check time of the current core, spinning the current core until current ticks of the current core equal the next budget check time of the current core.

Example 33 may be example 31, wherein the method may further comprise the interrupt handler, on determining that current ticks of the current core are greater than a next budget check time of the current core, setting the next budget check time of the current core to a sum of the current ticks of the current core and a budget time quantum of the current core; and resetting the corresponding performance counter of the current core which condition results in the interrupt that led to the interrupt handler being given execution control, with an access budget for a budget time quantum.

Example 34 may be one or more computer-readable media having instructions stored thereon that cause a computing device, in response to execution by the computing device, to: configure each of a plurality of corresponding performance counters of a plurality of cores of a processor of the computing device with an access budget of the corresponding core for a shared resource of the computing device for a budget time quantum; and monitor and control access of the shared resource by the cores, in accordance with the access budgets of the cores, utilizing the performance counters.

Example 35 may be example 34, wherein the computing device may be further caused to configure a control register, and use the control register, in conjunction with the performance counters, to manage access of the shared resource by the plurality of cores in accordance with their respective access budgets.

Example 36 may be example 35, wherein the computing device may be further caused to configure the control register to denote which of the plurality of cores are to have budget based control of access of the shared resource enabled.

Example 37 may be example 36, wherein the computing device may be further caused to configure the control register to denote a next budget check time, based on a budget time quantum, for each of the plurality of cores to have budget based control of access of the shared resource enabled.

Example 38 may be example 34, wherein the computing device may be further caused to configure each performance counter corresponding to a core to have budget based control of access of the shared resource enabled, with an access budget for a budget time quantum.

Example 39 may be example 38, wherein the access budget for a budget time quantum may be associated with a type of access events of the shared resource.

Example 40 may be example 38, wherein the computing device may be further caused to configure each performance counter corresponding to a core to have budget based control of access of the shared resource enabled, with a value equal to an overflow value minus the access budget for the budget time quantum.

Example 41 may be example 40, wherein the computing device may be further caused to configure each performance counter corresponding to a core to have budget based control of access of the shared resource enabled, to generate an interrupt on overflow.

Example 42 may be any one of examples 34-41, wherein the computing device may be further caused to monitor for accesses of the shared resource by the plurality of cores, and on detection of an access of the shared resource by a core, updates a corresponding performance counter if the accessing core has budget based control of access of the shared resource enabled.

Example 43 may be example 42, wherein the computing device may be further caused to deny a core with budget based control of access of the shared resource enabled, from further access of the shared resource, on detection of an indication from the corresponding performance counter that denotes the core as having reached its access budget for a budget time quantum.

Example 44 may be example 43, wherein the computing device may be further caused transfer execution control to an interrupt handler to deny the core with budget based control of access of the shared resource enabled, from further access of the shared resource, in response to an interrupt generated as a result of a corresponding performance counter reaches a condition that denotes the core as having reached its access budget for the budget time quantum.

Example 45 may be example 44, wherein on given execution control, the interrupt handler may: determine a current core; determine whether budget based access control of the shared resource is enabled for the current core; and on a determination that budget based access control of the shared resource is enabled for the current core, further determine whether current ticks of the current core are greater than a next budget check time of the current core.

Example 46 may be example 45, wherein on a determination that current ticks of the current core are not greater than a next budget check time of the current core, the interrupt handler may spin the current core until current ticks of the current core equal the next budget check time of the current core.

Example 47 may be example 46, wherein on a determination that current ticks of the current core are greater than a next budget check time of the current core, the interrupt handler may: set the next budget check time of the current core to a sum of the current ticks of the current core and a budget time quantum of the current core; and reset the corresponding performance counter of the current core which condition results in the interrupt that led to the interrupt handler being given execution control, with an access budget for a budget time quantum.

Example 48 may be an apparatus for computing, comprising: a processor having a plurality of cores; a resource coupled with the processor to be shared among the plurality of cores; and a plurality of performance counters correspondingly associated with the plurality of cores. The apparatus may further comprise means for configuring each of the plurality of performance counters with an access budget of the corresponding core for the shared resource for a budget time quantum; and means for monitoring and controlling access of the shared resource by the cores, in accordance with the access budgets of the cores, utilizing the performance counters.

Example 49 may be example 48, wherein means for configuring may further comprise means for configuring a control register with control data associated with the access budget, and monitoring and controlling further comprises utilizing the control register.

Example 50 may be example 49, wherein means for configuring may comprise means for configuring the control register to denote which of the plurality of cores are to have budget based control of access of the shared resource enabled.

Example 51 may be example 50, wherein means for configuring may comprise means for configuring the control register to denote a next budget check time, based on a budget time quantum, for each of the plurality of cores to have budget based control of access of the shared resource enabled.

Example 52 may be example 48, wherein means for configuring may comprise means for configuring each performance counter corresponding to a core to have budget based control of access of the shared resource enabled, with an access budget for a budget time quantum.

Example 53 may be example 52, wherein the access budget for a budget time quantum may be associated with a type of access events of the shared resource.

Example 54 may be example 52, wherein means for configuring may comprise means for configuring each performance counter corresponding to a core to have budget based control of access of the shared resource enabled, with a value equal to an overflow value minus the access budget for the budget time quantum.

Example 55 may be example 54, wherein means for configuring may comprise means for configuring each performance counter corresponding to a core to have budget based control of access of the shared resource enabled, to generate an interrupt on overflow.

Example 56 may be any one of examples 48-55, wherein means for monitoring and controlling may comprise means for monitoring for accesses of the shared resource by the plurality of cores, and means for, on detecting an access of the shared resource by a core, updating a corresponding performance counter if the accessing core has budget based control of access of the shared resource enabled.

Example 57 may be example 56, wherein means for monitoring and controlling may comprise means for denying a core with budget based control of access of the shared resource enabled, from further access of the shared resource, on detecting an indication from the corresponding performance counter that denotes the core as having reached its access budget for a budget time quantum.

Example 58 may be example 57, wherein means for monitoring and controlling may further comprise means for transferring execution control to an interrupt handler to deny the core with budget based control of access of the shared resource enabled, from further access of the shared resource, in response to an interrupt generated as a result of a corresponding performance counter reaches a condition that denotes the core as having reached its access budget for the budget time quantum.

Example 59 may be example 58, wherein the interrupt handler may comprise means for, on given execution control, determining a current core; determining whether budget based access control of the shared resource is enabled for the current core; and on determining that budget based access control of the shared resource is enabled for the current core, further determining whether current ticks of the current core are greater than a next budget check time of the current core.

Example 60 may be example 59, wherein the interrupt handler may further comprise means for, on determining that current ticks of the current core are not greater than a next budget check time of the current core, spinning the current core until current ticks of the current core equal the next budget check time of the current core.

Example 61 may be example 59, wherein the interrupt handler may further comprise means for, on determining that current ticks of the current core are greater than a next budget check time of the current core, setting the next budget check time of the current core to a sum of the current ticks of the current core and a budget time quantum of the current core; and resetting the corresponding performance counter of the current core which condition results in the interrupt that led to the interrupt handler being given execution control, with an access budget for a budget time quantum.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A computing device, comprising:
a processor having a plurality of cores;
a resource coupled with the processor to be shared among the plurality of cores;
a plurality of performance counters correspondingly associated with the plurality of cores to store access budgets of the shared resource of the plurality of cores; and
a performance monitor coupled with the processor, the resource and the performance counters to manage access of the shared resource by the plurality of cores in accordance with their respective access budgets stored in the performance counters.

2. The computing device of claim 1, further comprising a control register; wherein the performance monitor is further coupled with the control register, and use the control register, in conjunction with the performance counters to manage access of the shared resource by the plurality of cores in accordance with their respective access budgets.

3. The computing device of claim 2, wherein the performance monitor is to configure the control register to denote which of the plurality of cores are to have budget based control of access of the shared resource enabled.

4. The computing device of claim 3, wherein the performance monitor is to further configure the control register to denote a next budget check time, based on a budget time quantum, for each of the plurality of cores to have budget based control of access of the shared resource enabled.

5. The computing device of claim 1, wherein the performance monitor is to configure each performance counter corresponding to a core to have budget based control of access of the shared resource enabled, with an access budget for a budget time quantum.

6. The computing device of claim 5, wherein the access budget for a budget time quantum is associated with a type of access events of the shared resource.

7. The computing device of claim 5, wherein the performance monitor is to configure each performance counter corresponding to a core to have budget based control of access of the shared resource enabled, with a value equal to an overflow value minus the access budget for the budget time quantum.

8. The computing device of claim 7, wherein the performance monitor is to configure each performance counter corresponding to a core to have budget based control of access of the shared resource enabled, to generate an interrupt on overflow.

9. The computing device of claim 1, wherein the performance monitor is to monitor for accesses of the shared resource by the plurality of cores, and on detection of an access of the shared resource by a core, update a corresponding performance counter if the accessing core has budget based control of access of the shared resource enabled.

10. The computing device of claim 9, wherein the performance monitor is to deny a core with budget based control of access of the shared resource enabled, from further access of the shared resource, on detection of an indication from the corresponding performance counter that denotes the core as having reached its access budget for a budget time quantum.

11. The computing device of claim 10, further comprising an interrupt handler to be given execution control to deny the core with budget based control of access of the shared resource enabled, from further access of the shared resource, in response to an interrupt generated as a result of a corresponding performance counter reaching a condition that denotes the core as having reached its access budget for the budget time quantum.

12. The computing device of claim 11, wherein on given execution control, the interrupt handler is to:
determine a current core;
determine whether budget based access control of the shared resource is enabled for the current core; and
on a determination that budget based access control of the shared resource is enabled for the current core, further determine whether current ticks of the current core are greater than a next budget check time of the current core.

13. The computing device of claim 12, wherein on a determination that current ticks of the current core are not greater than a next budget check time of the current core, the interrupt handler is to spin the current core until current ticks of the current core equal the next budget check time of the current core.

14. The computing device of claim 12, wherein on a determination that current ticks of the current core are greater than a next budget check time of the current core, the interrupt handler is to:
set the next budget check time of the current core to a sum of the current ticks of the current core and a budget time quantum of the current core; and
reset the corresponding performance counter of the current core which condition results in the interrupt that led to the interrupt handler being given execution control, with an access budget for a budget time quantum.

15. The computing device of claim 1, wherein the performance monitor is part of an operating system or hypervisor of the computing device.

16. A method for controlling core accesses to a shared resource on a computing device, comprising:
configuring, by a performance monitor of the computing device, each of a plurality of corresponding performance counters of a plurality of cores of a processor of the computing device with an access budget of the corresponding core for the shared resource for a budget time quantum; and
monitoring and controlling, by the performance monitor, access of the shared resource by the cores, in accordance with the access budgets of the cores, utilizing the performance counters.

17. The method of claim 16, wherein monitoring and controlling comprises monitoring for accesses of the shared resource by the plurality of cores, and on detecting an access of the shared resource by a core, updating a corresponding performance counter if the accessing core has budget based control of access of the shared resource enabled.

18. One or more computer-readable media having instructions stored thereon that cause a computing device, in response to execution by the computing device, to:
configure each of a plurality of corresponding performance counters of a plurality of cores of a processor of the computing device with an access budget of the corresponding core for a shared resource of the computing device for a budget time quantum; and
monitor and control access of the shared resource by the cores, in accordance with the access budgets of the cores, utilizing the performance counters.

19. The computer-readable storage medium of claim 18, wherein the computing device is further caused to configure a control register, and use the control register, in conjunction with the performance counters, to manage access of the shared resource by the plurality of cores in accordance with their respective access budgets;
wherein the computing device is further caused to configure the control register to denote which of the plurality of cores are to have budget based control of access of the shared resource enabled; and
wherein the computing device is further caused to configure the control register to denote a next budget check time, based on a budget time quantum, for each of the plurality of cores to have budget based control of access of the shared resource enabled.

20. The computer-readable storage medium of claim 18, wherein the computing device is further caused to configure each performance counter corresponding to a core to have budget based control of access of the shared resource enabled, with an access budget for a budget time quantum; wherein the access budget for a budget time quantum is associated with a type of access events of the shared resource; and wherein the computing device is further caused to configure each performance counter corresponding to a core to have budget based control of access of the shared resource enabled, with a value equal to an overflow value minus the access budget for the budget time quantum; wherein the computing device is further caused to configure each performance counter corresponding to a core to have budget based control of access of the shared resource enabled, to generate an interrupt on overflow.

21. The computer-readable storage medium of claim 18, wherein the computing device is further caused to monitor for accesses of the shared resource by the plurality of cores, and on detection of an access of the shared resource by a core, updates a corresponding performance counter if the accessing core has budget based control of access of the shared resource enabled; and wherein the computing device is further caused to deny a core with budget based control of access of the shared resource enabled, from further access of the shared resource, on detection of an indication from the corresponding performance counter that denotes the core as having reached its access budget for a budget time quantum.

22. The computer-readable storage medium of claim 21, wherein the computing device is further caused transfer execution control to an interrupt handler to deny the core with budget based control of access of the shared resource enabled, from further access of the shared resource, in response to an interrupt generated as a result of a corresponding performance counter reaches a condition that denotes the core as having reached its access budget for the budget time quantum.

23. The computer-readable storage medium of claim 22, wherein on given execution control, the interrupt handler is to:
determine a current core;
determine whether budget based access control of the shared resource is enabled for the current core; and
on a determination that budget based access control of the shared resource is enabled for the current core, further determine whether current ticks of the current core are greater than a next budget check time of the current core.

24. The computer-readable storage medium of claim 23, wherein on a determination that current ticks of the current core are not greater than a next budget check time of the current core, the interrupt handler is to spin the current core until current ticks of the current core equal the next budget check time of the current core.

25. The computer-readable storage medium of claim 23, wherein on a determination that current ticks of the current core are greater than a next budget check time of the current core, the interrupt handler is to:
set the next budget check time of the current core to a sum of the current ticks of the current core and a budget time quantum of the current core; and
reset the corresponding performance counter of the current core which condition results in the interrupt that led to the interrupt handler being given execution control, with an access budget for a budget time quantum.
